(19) United States
(12) Patent Application Publication
(10) Pub. No.: US 2010/0323206 A1
(43) Pub. Date: Dec. 23, 2010

(54) SOFT MAGNETIC MATERIAL AND PRODUCTION METHOD THEREFOR

(75) Inventors: Shingo Soma, Tochigi (JP); Kazuhito Hiraga, Tochigi (JP); Yoshiki Hirano, Tochigi (JP)

Correspondence Address: ARENT FOX LLP, 1050 CONNECTICUT AVENUE, N.W., SUITE 400, WASHINGTON, DC, 20036, US

(73) Assignee: Honda Motor Co., Ltd.

(21) Appl. No.: 12/864,791

(22) PCT Filed: Jan. 8, 2009
(86) PCT No.: PCT/JP2009/000042

§ 371 Date: Jul. 27, 2010

(30) Foreign Application Priority Data
Jan. 31, 2008 (JP) 2008-021736
Nov. 28, 2008 (JP) 2008-303718

(51) Int. Cl. B32B 15/04; B32B 15/18; C04B 35/653; B29C 43/20

(52) U.S. Cl. 428/446; 428/469; 264/332; 264/319

(57) ABSTRACT

A film composed of a metal or a semimetal is formed on a surface of a soft magnetic powder including iron and oxygen (in step S102). In this case, a silicon-containing film is desirably formed on a surface of the film. Next, compaction is performed on the soft magnetic powder, so that a green compact is obtained (in step S103). Since the film is a metal film or a semimetal film having a high ductility, the density of the green compact produced by the compaction can be higher, and generation of damage, such as cracks or the like, can be prevented in the film. The effects can be also obtained in a case of formation of the silicon-containing film. Next, the green compact is subjected to heating, so that a surface and an interface of the soft magnetic powder of the green compact are oxidized, so that an insulation film is formed (in step S104). Generation of eddy current loss can be prevented by the oxide film. As a result, productivity and magnetic properties can be improved.

### TECHNICAL FIELD

The present invention relates to a production method for soft magnetic materials in which an insulation film is formed on a surface and an interface of a soft magnetic powder including iron. In particular, the present invention relates to an improvement in formation of the insulation film.

### BACKGROUND ART

Soft magnetic materials are used for electromagnetic parts such as motors, transformers, and the like. FIGS. 9 and 10A to 10C are diagrams for explaining a conventional production method for soft magnetic materials. FIG. 9 is a diagram showing production processes, and FIGS. 10A to 10C are diagrams showing a schematic structure of products in each production process. In FIGS. 10A and 10B, only one particle of a soft magnetic powder is shown for the sake of convenience. In the conventional production method for soft magnetic materials, as shown in FIG. 10A, a soft magnetic powder 101 including iron (Fe) is prepared (in step S1), and as shown in FIG. 10B, an insulation film 102 is formed on a surface of the soft magnetic powder 101 (in step S2). Next, as shown in FIG. 10C, compaction is performed on the soft magnetic powder 101 in a die (not shown in FIG. 10C), so that a green compact 103 is produced (in step S3).

Next, the green compact 103 is subjected to heating, so that strains generated of the green compact 103 by the compaction are relieved (in step S4). Thus, a soft magnetic material, in which a surface and an interface of the soft magnetic powder 101 are subjected to insulation coating, is produced. The surface of the soft magnetic powder 101 is defined as a portion (for example, a portion 101S in FIG. 10C) at which the soft magnetic powder 101, having the insulation film 102 formed thereon after the heating, contacts a gap. The interface of the soft magnetic powder 101 is defined as a portion (which is chemically-bound by the heating, for example, the portion being a portion 101I in FIG. 10C), at which the particles of the soft magnetic powder 101 having the insulation film 102 formed thereon after the heating, contact to each other.

The insulation film 102 on the surface and the interface of the soft magnetic powder 101 is formed for improvement in magnetic properties of electromagnetic parts. Specifically, the insulation film 102 increases the efficiency of the electromagnetic parts by inhibiting generation of eddy current in transmission of the alternate-current magnetic field. In the production method for soft magnetic materials, since the heating is desirably performed at a high temperature in order to perform the relieving of the strains effectively. Therefore, as a material of the insulation film, resins which are inferior in fire resistance are not used, but inorganic materials such as metal oxides are used. For example, at least one selected from the group consisting of an aluminum oxide, a zirconium oxide, and a silicon oxide is used as the metal oxide (for example, see Japanese Unexamined Patent Application Publication No. 2005-79511).

However, since an inorganic insulation film of a metal oxide or the like is hard, there were the following problems. FIGS. 11A and 11B show a compacting process of the conventional production method for soft magnetic materials. FIG. 11A is a side sectional view and FIG. 11B is an enlarged view in which a structure in FIG. 11A is simplified. In FIG. 11B, only one particle of a green compact is shown for the sake of convenience. As shown in FIG. 11A, a green compact 103, which is produced by compaction, has a low density, so that magnetic properties of the soft magnetic material are deteriorated.

As shown in FIG. 11B, damage (crack C or the like) may easily occur in the insulation film 102 by the compaction, eddy current loss of the soft magnetic material may be greater, and the magnetic properties of the soft magnetic material may be further deteriorated. Since the strength of the green compact 103 is lower, in processes after the compaction, damage (cracking or the like) may easily occur, it may be difficult to handle the green compact 103. Due to this, the productivity of the soft magnetic material may be deteriorated. In FIGS. 11A and 11B, reference symbols D1 and D2 denote an upper die and a lower die.

### DISCLOSURE OF THE INVENTION

An object of the present invention is to provide a production method for soft magnetic materials, which can improve productivity, can realize high resistance, and can improve magnetic properties.

According to one aspect of the present invention, a first soft magnetic material is produced by compaction of a soft magnetic powder which includes iron and has an insulation film formed on a surface of the soft magnetic powder. The insulation film is an insulation film including an oxide of a metal or a semimetal and silicon.

According to another aspect of the present invention, a second soft magnetic material is produced by compaction of a soft magnetic powder which includes iron and has an insulation film formed on a surface of the soft magnetic powder. The insulation film has: a first insulation film which is composed of an oxide of a metal or a semimetal; and a second insulation film which is composed of an oxide of the metal or the semimetal and silicon, wherein the first insulation film and the second insulation film are formed in turn from the surface of the soft magnetic powder.

According to another aspect of the present invention, a first production method for a soft magnetic material includes: forming a film composed of a metal or a semimetal on a surface of a soft magnetic powder including iron and oxygen; compacting the soft magnetic powder having the film, so that a green compact of the soft magnetic powder is obtained; heating the green compact, so that the film of the green compact is oxidized to an insulation film.

In the first production method for a soft magnetic material according to the present invention, a film composed of a metal or a semimetal is formed on a surface of a soft magnetic powder including iron and oxygen. Compaction is performed on the soft magnetic powder having the film, so that a green compact of the soft magnetic powder is obtained. The green compact is subjected to heating, so that the film of the green compact is oxidized to an insulation film on a surface and an interface of the soft magnetic powder. The surface of the soft magnetic powder is defined as a portion at which the soft magnetic powder, having the insulation film formed thereon after the heating, contacts a gap. The interface of the soft magnetic powder is defined as a portion (which is chemically-bound by the heating), at which particles of the soft magnetic powder having the insulation film formed thereon after the heating, contact each other. The following description is based on the definitions.

In the first production method, a film is formed on a surface of a soft magnetic powder including iron and oxygen, and compaction is performed on the soft magnetic powder. In this case, since the film formed on the surface of the soft magnetic powder is a metal film or a semimetal film composed of at least one of a metal and a semimetal, thereby having a high ductility, the film can conform to plastic deformation of the soft magnetic powder. Thus, the density of the green compact produced by the compaction can be higher, and generation of damage, such as cracks or the like, can be prevented in the film. Therefore, magnetic properties can be improved. Since the strength of the green compact can be improved, handling of the green compact can be easily performed in processes after the compaction. As a result, the productivity can be improved.

The green compact is subjected to heating, so that the film on the surface and the interface of the soft magnetic powder is oxidized, and the oxide film is thereby formed as the insulation film. In the formation of the oxide film, the film on the surface and the interface of the soft magnetic powder can be reacted with oxygen in the soft magnetic powder. In this case, since the film has no damage as described above, insulation properties of the oxide film can be good. Thus, since generation of eddy current loss of the soft magnetic material can be prevented, magnetic properties can be further improved. Binding of metals, binding of semimetals, binding of a metal and a semimetal start at a lower temperature than binding of oxides, and the film is changed to the oxide film by the binding reaction, so that the strength can be further improved. As a result, mechanical properties can be further improved. It is unnecessary that nonmagnetic elements or compounds thereof be coated as a thick insulation film and they be added to an insulation film. The above effects can be obtained in the soft magnetic material better than in the conventional soft magnetic material having the insulation film in the overall thickness is the same. Thus, the realization of the high resistance, and the improvement in the productivity and in the magnetic properties can be simultaneously performed.

According to a second production method and a third production method for a soft magnetic material according to the present invention, a silicon-containing film including silicon is formed on a surface of the film obtained in the above first production method, heating is performed after compaction, so that the film and the silicon-containing film are oxidized to an insulation film. In this case, in the second production method, the insulation film (which is composed of an oxide of the metal or the semimetal or silicon) of the above first soft magnetic material of the present invention is obtained as the insulation film. In the third production method, the insulation film (which has a first insulation film and a second insulation film, the first insulation film being composed of an oxide of the metal or the semimetal, the second insulation film being composed of an oxide of the metal or the semimetal and silicon) of the above second soft magnetic material of the present invention is obtained as the insulation film.

That is, according to another aspect of the present invention, a second production method for a soft magnetic material includes: forming a film composed of a metal or a semimetal on a surface of a soft magnetic powder including iron and oxygen; forming a silicon-containing film including silicon on a surface of the film; compacting the soft magnetic powder having the film and the silicon-containing film, so that a green compact of the soft magnetic powder is obtained; and heating the green compact, so that the film and the silicon-containing film of the green compact are oxidized to an insulation film, wherein the insulation film is an insulation film composed of an oxide of the metal or the semimetal and silicon.

According to another aspect of the present invention, a third production method for a soft magnetic material includes: forming a film composed of a metal or a semimetal on a surface of a soft magnetic powder including iron and oxygen; forming a silicon-containing film including silicon on a surface of the film; compacting the soft magnetic powder having the film and the silicon-containing film, so that a green compact of the soft magnetic powder is obtained; and heating the green compact, so that the film and the silicon-containing film of the green compact are oxidized to an insulation film, wherein the insulation film has: a first insulation film which is composed of an oxide of the metal or the semimetal; and a second insulation film which is composed of an oxide of the metal or the semimetal and silicon, wherein the first insulation film and the second insulation film are formed in turn from the surface of the soft magnetic powder.

In the second production method and the third second production method, in addition to the effects by the first production method, the following effects can be obtained. When there is a portion of the surface of the soft magnetic powder, which is not covered with the film, since the portion can be covered with the silicon-containing film, the coating of the entire surface of the soft magnetic powder can be sufficiently performed. Since the silicon-containing film has a high ductility in the same manner as the above film, the silicon-containing film can conform to plastic deformation of the soft magnetic powder in the compaction. As a result, the effects (the improvements in the magnetic properties and the productivity) after the compaction in the first embodiment can be obtained better.

Since the insulation film can be formed on the entire surface of the soft magnetic powder by heating the green compact, the effects (the improvements in the magnetic properties and the productivity) after the heating in the first embodiment can be obtained better. In this case, since the heating can be performed at a high temperature for a long time period, the bonding of the particles can be strong, so that the above effects can be obtained better. Even when amount of the film is small, the above effects can be obtained by the coating of the silicon-containing film, so that material amount of the film can be reduced. As a result, the production cost can be reduced. The above effects can be obtained in the soft magnetic material better than in the conventional soft magnetic material having the insulation film in which the overall thickness is the same. Thus, the realization of the high resistance, and the improvement in the productivity and in the magnetic properties can be simultaneously performed.

In particular, when aluminum (Al) is used as the metal of the film, the insulation film, formed after the heating in the second production method, and the second insulation film, formed after the heating in the third production method, can be composed of aluminum-silicon oxide, so that the insulation properties can be better. Thus, generation of eddy current loss can be prevented, so that magnetic properties can be further improved. Since the strength can be further improved, mechanical properties can be further improved.

According to a desirable embodiment, the soft magnetic materials and the production methods therefor can use various structures. For example, an oxide of the metal and an oxide of the semimetal can have absolute values of standard free energy of formation, and the absolute values can be desirably larger than that of an iron oxide. In this embodiment, in the heating, the metal and the semimetal can reduce oxygen in the soft magnetic powder including iron and oxygen, so that the oxide film can be easily formed.

According to the first production method for soft magnetic material of the present invention, the film composed of the metal or the semimetal is formed on the surface of the soft magnetic powder including iron and oxygen, the compaction is performed on the soft magnetic powder having the film, and the green compact is subjected to heating, so that the film on the surface and the interface of the soft magnetic powder is oxidized to the insulation film. Thus, the density can be higher, the strength can be greater, and generation of damage in the oxide film can be prevented. As a result, the realization of the high resistance, and the improvement in the magnetic properties and in the mechanical properties can be simultaneously performed.

According to the first soft magnetic material and the second production method of the present invention, since the silicon-containing film including silicon is formed on the surface of the film, the effects by the first production method can be obtained better.

According to the second soft magnetic material and the third production method of the present invention, since the silicon-containing film including silicon is formed on the surface of the film, the effects by the first production method can be obtained better.

### BRIEF DESCRIPTION OF DRAWINGS

FIG. 1 is a process diagram showing a production method for soft magnetic materials of a first embodiment according to the present invention.

FIGS. 2A to 2D are diagrams showing a schematic structure of products in each production process of a first embodiment according to the present invention.

FIGS. 3A and 3B show a compacting process of the conventional production method for soft magnetic materials. FIG. 3A is a side sectional view and FIG. 3B is an enlarged view in which a structure in FIG. 3A is simplified.

FIG. 4 is a schematic side sectional view showing one example of a construction of a powder sputtering apparatus for soft magnetic materials of embodiments according to the present invention.

FIG. 5 is a process diagram showing a production method for soft magnetic materials of a second embodiment according to the present invention.

FIGS. 6A to 6D are diagrams showing a schematic structure of products in each production process of a second embodiment according to the present invention.

FIG. 7 is a diagram showing a schematic structure of products in a process after the process shown in FIG. 6D.

FIG. 8 is a diagram showing a schematic structure of another example of products in a process after the process shown in FIG. 6D.

FIG. 9 is a process diagram showing a conventional production method for soft magnetic materials.

FIGS. 10A to 10C are diagrams showing a schematic structure of products in each production process.

FIGS. 11A and 11B show a compacting process of the conventional production method for soft magnetic materials. FIG. 11A is a side sectional view and FIG. 11B is an enlarged view in which a structure in FIG. 11A is simplified.

### EXPLANATION OF REFERENCE NUMERALS

1 denotes a soft magnetic material, 2 denotes an oxide film, 3 denotes a film (a metal film or a semimetal film), 4 and 14 denotes a green compact, 5 and 15A denote an insulation film, 15B denotes insulation film (first insulation film), 15C denotes insulation film (second insulation film), 6 and 16 denote a soft magnetic material, and 13 denotes a silicon-containing film.

### BEST MODE FOR CARRYING OUT THE INVENTION

### 1. First Embodiment

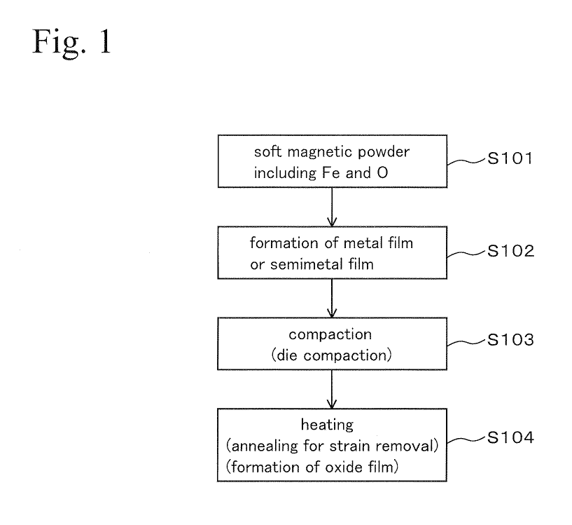

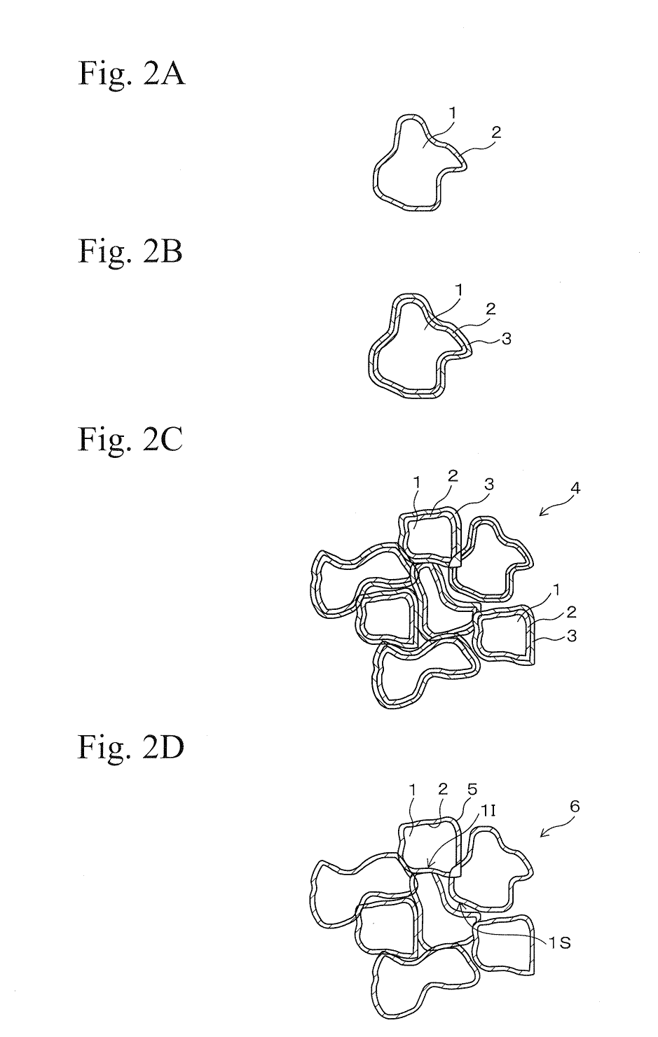

A first embodiment (an embodiment of the first production method for a soft magnetic material) of the present invention will be described with reference to the figures hereinafter. FIGS. 1 and 2A to 2D are diagrams for explaining a production method for soft magnetic materials of the first embodiment according to the present invention. FIG. 1 is a diagram showing production processes, and FIGS. 2A to 2D are diagrams showing a schematic structure of products in each production process. In FIGS. 2A and 2B, only one particle of a soft magnetic powder is shown.

First, as shown in FIG. 2A, a soft magnetic powder 1 including iron (Fe) and oxygen (O) is prepared (in step S101). Specifically, an oxide film 2 composed of an iron oxide is formed on a surface of a soft magnetic powder 1. For example, pure iron, iron-nickel (Fe—Ni), iron-silicon (Fe—Si), iron-cobalt (Fe—Co), and iron-aluminum-silicon (Fe—Al—Si) are used as a material of the soft magnetic powder 1.

Next, as shown in FIG. 2B, a film 3, which is a metal film or a semimetal film, is formed on a surface of the soft magnetic powder 1 (in step S102). The film 3 is a film composed of a metal or a semimetal. For example, a material of the film 3 is used such that an oxide of the material of the film 3 has an absolute value of standard free energy of formation, and this absolute value is larger than that of an iron oxide. Specifically, aluminum (Al), silicon (Si), magnesium (Mg), niobium (Nb), lithium (Li), gadolinium (Gd), yttrium (Y), praseodymium (Pr), lanthanum (La), and Nd (Neodymium) can be used. The thickness of the film 3 is not particularly limited, and this thickness is desirably 1 nm to 10 μm. In a case in which the thickness of the film 3 is less than 1 nm, when the film 3 is oxidized by the subsequent heating and an oxide film is thereby formed as an insulation film 5, insulation effects of the oxide film may be small. In a case in which the thickness of the film 3 exceeds 10 μm, when the insulation film 5 is formed, the magnetic permeability is greatly decreased, and the following soft magnetic material may not be useful.

In the formation of the film 3, for example, a powder sputtering apparatus 200 shown in FIG. 4 is used. The powder sputtering apparatus 200 is equipped with a housing 201 of which an inner portion is vacuumized by a vacuum pump (not shown in FIG. 4), and a rotational barrel 202, which is rotatable in a predetermined direction (for example, in an arrow direction at the right side in FIG. 4) is provided in the inner portion of the housing 201. In an inner portion of the rotational barrel 202, a target 203 for a material of the film 3 is disposed so as to face an upper surface of a bottom portion of the rotational barrel 202 to which the soft magnetic power 1 is supplied. The soft magnetic power 1 is supplied from a sample box 204.

In this powder sputtering apparatus 200, a high voltage is applied to the target 203, a noble gas element and nitrogen, which are ionized, collide with the target 203. Then, atoms released from a surface of the target 203 arrive at the soft magnetic power 1 on the upper surface of bottom portion of the rotational barrel 202, and the film 3 is formed on the surface of the soft magnetic power 1. In this case, since the soft magnetic power 1 is flowed by rotation of the rotational barrel 202, the formation of the film 3 is performed on the entire surface of powder particles of the soft magnetic power 1.

The formation method for the film 3 is not limited to the above sputtering, and various modifications of the formation method can be used. For example, instead of the sputtering, a vapor phase film formation method (thermal deposition, ion plating, or the like), a wet type film formation method (plating or the like), a chemical vapor phase method (pyrolysis, vapor phase reduction, or the like), or a mechanical film formation method (mechanofusion, hybridization, or the like) may be used.

Next, as shown in FIG. 2C, compaction is performed on the soft magnetic powder 1, which has the film 3 formed on the surface thereof, in a die (not shown in FIG. 2C), so that a green compact 4 is produced (in step S103). The compaction pressure is not particularly limited and is desirably 100 MPa to 2500 MPa. When the compaction pressure is less than 100 MPa, the density of the green compact 4 may be lower, and magnetic properties may be deteriorated. When the compaction pressure exceeds 2500 MPa, the life of the die may be short, and increase in cost and deterioration of productivity may be caused, so that this case may not be useful. The compaction temperature is not particularly limited. For example, the compaction temperature is room temperature, or warm condition in which the temperature is high may be used. A lubricant in the compaction may be used if necessary.

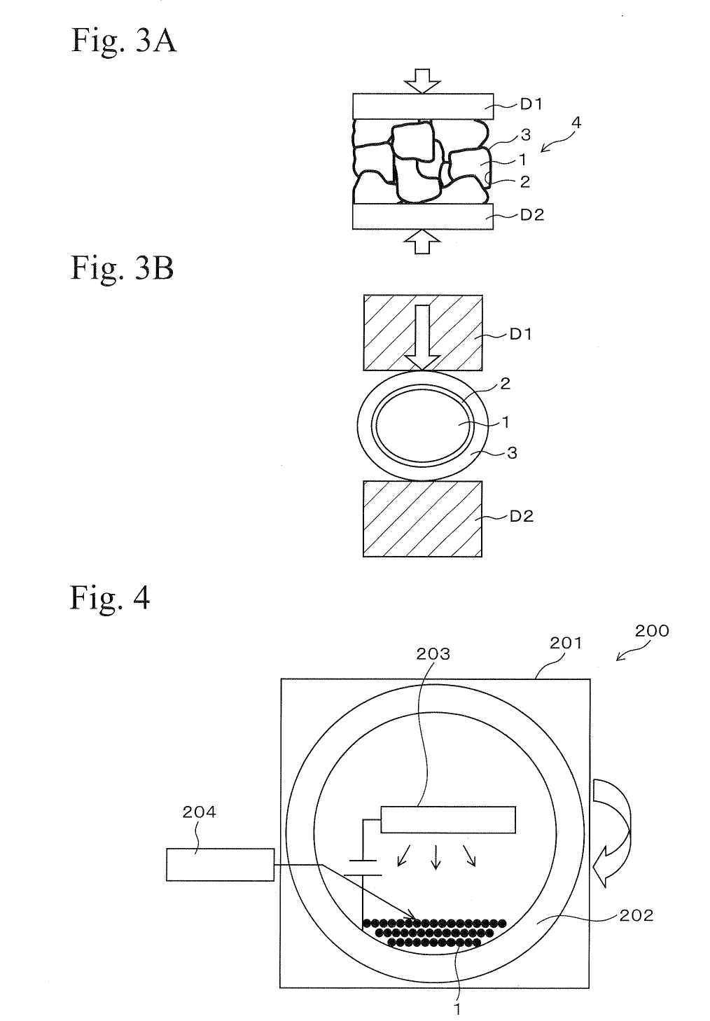

In this compaction, since the film 3 formed on the surface of the soft magnetic powder 1 has a high ductility, the film 3 can conform to plastic deformation of the soft magnetic powder 1. Thus, as shown in FIG. 3A, the density of the green compact 4 produced by the compaction can be higher, and as shown in FIG. 3B, generation of damage, such as cracks or the like, can be prevented in the film 3 in the compaction.

Next, the green compact 4 is subjected to heating, so that strains, which are generated in the green compact 4 by the compaction, are relieved, and the film 3 on the surface 1S and the interface 11 of the soft magnetic powder 1 is oxidized and an oxide film is thereby formed as the insulation film 5 (in step S104). In the formation of the insulation film 5, the film 3 is reacted with oxygen in the iron oxide of the oxide film 2. The atmosphere in the heating is not particularly limited. For example, a vacuum atmosphere, air, argon gas, or nitrogen gas is used for the atmosphere. The heating temperature is not be particularly limited and it is desirably 400 degrees C. or more. When the heating temperature is less than 400 degrees C., the strains which are generated by the compaction cannot be relieved sufficiently.

In this heating, since damage is not generated in the film 3 on the surface of the soft magnetic powder 1 in the above manner, insulation properties of the insulation film 5 are good. Binding of metals, binding of semimetals, binding of a metal and a semimetal start at a lower temperature than binding of oxides, and the film 3 is changed to the oxide film by the binding reaction, so that the strength can be further improved. In the above manner, a soft magnetic material 6, in which the surface and the interface of the soft magnetic powder is subjected to insulation coating, is produced.

As described above, in the production method for the soft magnetic material 6 of the first embodiment, the compaction is performed on the soft magnetic powder 1 which includes iron and oxygen and has the film 3 (the metal film or the semimetal film) formed on the surface thereof. Thus, the density of the green compact 4 produced by the compaction can be higher, and generation of damage, such as cracks or the like, can be prevented in the film 3. Therefore, magnetic properties can be improved. Since the strength of the green compact 4 can be improved, handling of the green compact 4 can be easily performed in processes after the compaction. As a result, the productivity of the soft magnetic material 6 can be improved.

Since the green compact 4 is subjected to heating, so that the film 3 on the surface 1S and the interface 1I of the soft magnetic powder 1 is oxidized and the oxide film is thereby formed as the insulation film 5. Thus, since generation of eddy current loss of the soft magnetic material can be prevented, magnetic properties can be further improved. Since the strength can be further improved by the heating, mechanical properties can be further improved. It is unnecessary that nonmagnetic elements or compounds thereof be coated as a thick insulation film and they be added to an insulation film. The above effects can be obtained in the soft magnetic material 6 better than in the conventional soft magnetic material having the insulation film in the overall thickness is the same. Thus, the realization of the high resistance, and the improvement in the productivity and in the magnetic properties can be simultaneously performed.

In particular, the material of the film 3 is used such that the oxide of the material of the film 3 has an absolute value of standard free energy of formation and this absolute value is larger than that of an iron oxide of the oxide film 2. Thus, the material of the film 3 can reduce oxygen in the iron oxide in the heating. Therefore, the oxide film can be easily formed as the insulation film 5.

### 2. Second Embodiment

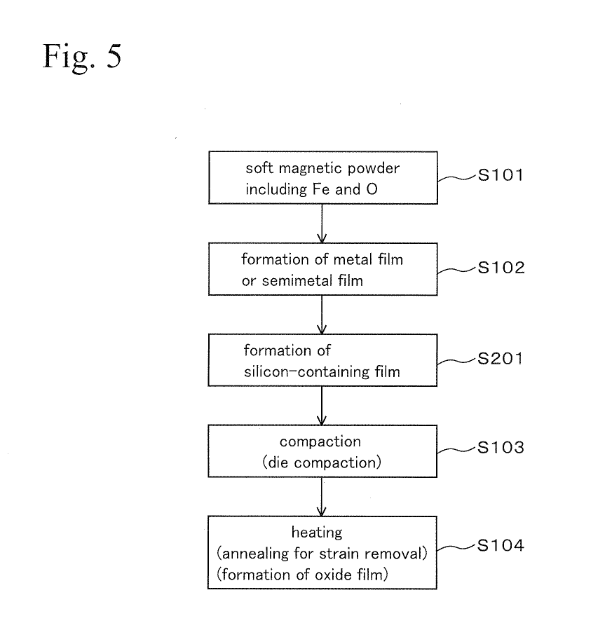

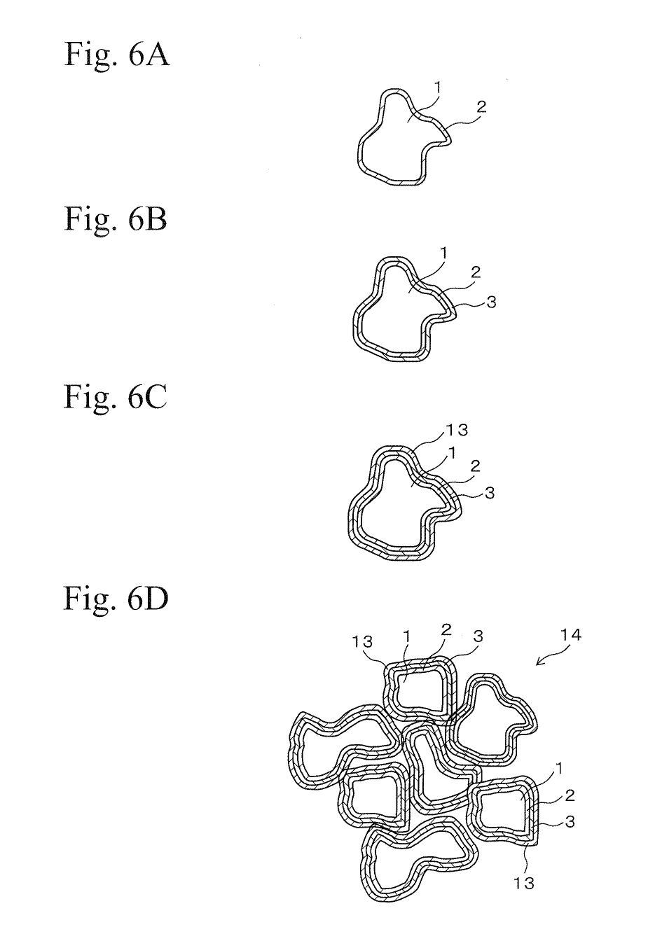

A second embodiment (an embodiment of the first and the second soft magnetic materials and the production methods (the second and the third production methods) therefor according to the present invention will be described with reference to the figures hereinafter. FIGS. 5 and 6A to 6D are diagrams for explaining a production method for soft magnetic materials of the second embodiment according to the present invention. FIG. 5 is a diagram showing production processes, and FIGS. 6A to 6D are diagrams showing a schematic structure of products in each production process. In FIGS. 6A and 6B, only one particle of a soft magnetic powder is shown. In the second embodiment, the same reference numerals are used for the same components as those in the first embodiment, and explanation of the same components performing the same actions as those in the first embodiment is omitted.

First, as shown in FIG. 6A, in the same manner as in the first embodiment, after a soft magnetic powder 1 including iron (Fe) and oxygen (O) is prepared (in step S101), as shown in FIG. 6B, a film 3, which is a metal film or a semimetal film, is formed on a surface of the soft magnetic powder 1 (in step S102). In this case, the materials other than silicon, which are used in the first embodiment, are used as the material of the film 3.

Next, as shown in FIG. 6C, a silicon-containing film 13 including silicon is formed on the surface of the film 3 (in step S201). For example, a silicon compound is used as a material of the silicon-containing film 13, and the material of the silicon-containing film 13 may be inorganic or organic. In the formation of the silicon-containing film 13, a mixing method, a wet type method, or a spray dry method, or the like is used. Specifically, a barrel mixing method, a gas atomization method, or an ultrasonic dispersion method is used.

In the second embodiment, since the silicon-containing film 13 including silicon is formed on the surface of the film 3, when there is a portion of the surface of the soft magnetic powder 1, which is not covered with the film 3, the portion can be covered with the silicon-containing film 13. Thus, the coating of the entire surface of the soft magnetic powder 1 can be sufficiently performed. The overall thickness of the film 3 and the silicon-containing film 13 is not particularly limited. The overall thickness of the film 3 and the silicon-containing film 13 is usefully set such that the thickness of the insulation film 15, which is formed by heating of the film 3 and the silicon-containing film 13, is 1 nm to 10 μm. The overall thickness of the film 3 and the silicon-containing film 13 is desirably set such that the thickness of the insulation film 15 after the heating is 100 nm or less. When the thickness of the insulation film 15 exceeds 10 μm, the magnetic permeability is greatly decreased, and the following soft magnetic material may not be useful.

Next, as shown in FIG. 6D, in the same manner as in the first embodiment, compaction is performed on the soft magnetic powder 1, which has the film 3 and the silicon-containing film 13 formed on the surface thereof, in a die (not shown in FIG. 6D), so that a green compact 14 is produced (in step S103). In this compaction, since the silicon-containing film 13 has a high ductility in the same manner as the film 3, the silicon-containing film 13 can conform to plastic deformation of the soft magnetic powder 1.

Next, the green compact 14 is subjected to heating, so that strains, which are generated in the green compact 14 by the compaction, are relieved, and the film 3 and the silicon-containing film 13 on the surface 1S and the interface 1I of the soft magnetic powder 1 are oxidized, and an oxide film is thereby formed as an insulation film (in step S104). The atmosphere in the heating may be set in the same manner as in the first embodiment. The heating temperature is not particularly limited, and it is desirably 400 degrees C. or more. When the heating temperature is less than 400 degrees C., the strains which are generated by the compaction cannot be relieved sufficiently.

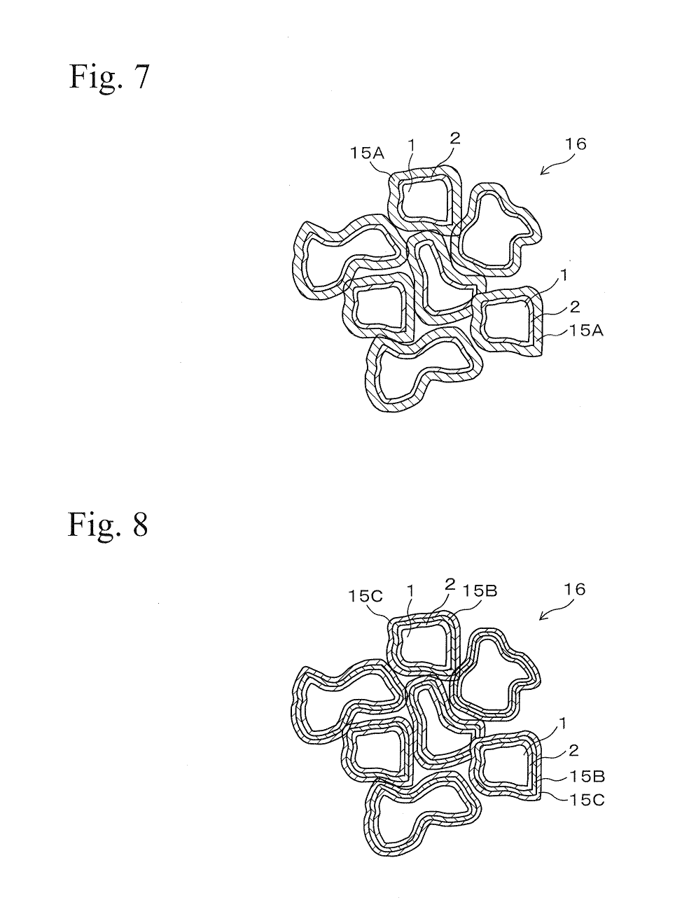

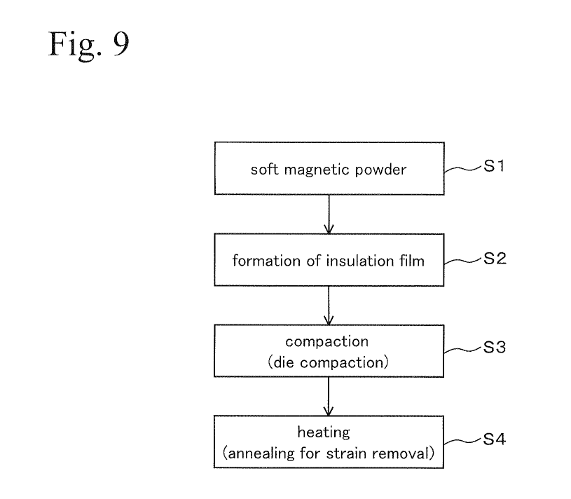

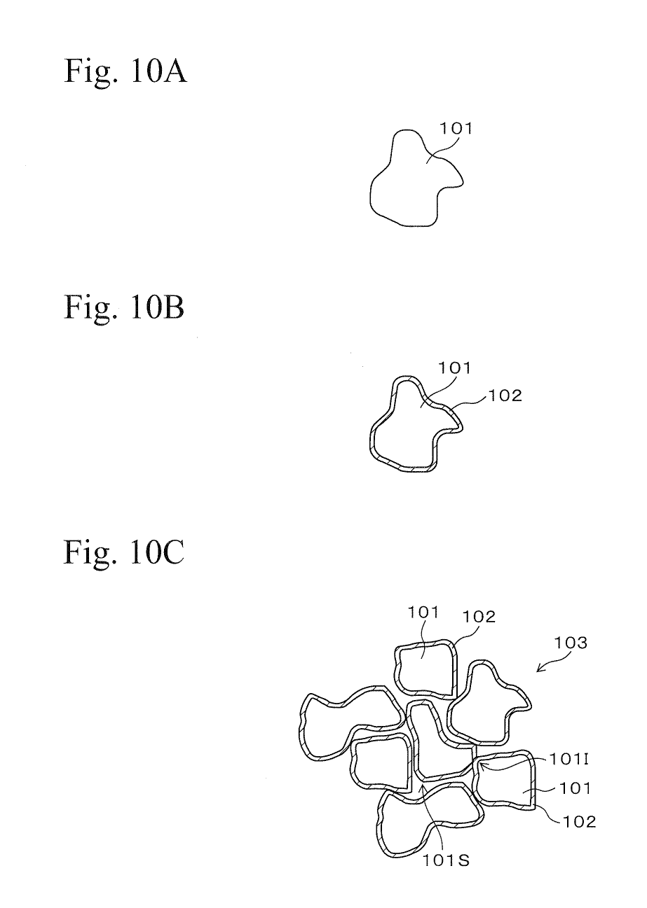

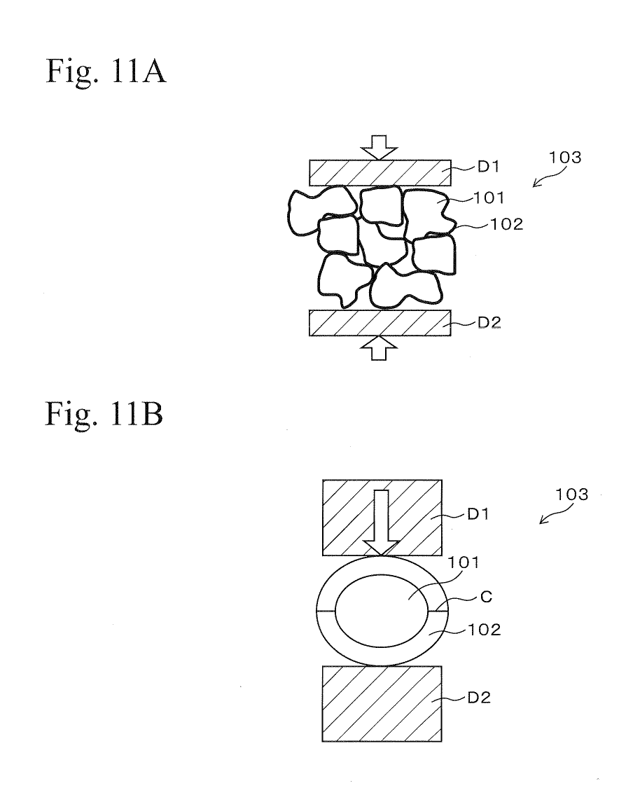

As shown in FIG. 7, the insulation film of the second embodiment is an insulation film 15A composed of an oxide of the material (metal or semimetal) of the film 3 and the material (silicon) of the silicon-containing film 13. Alternatively, as shown in FIG. 8, the insulation film of the second embodiment has an insulation film 15B (first insulation film) and an insulation film 15C (second insulation film), which are formed in turn. The insulation film 15B is composed of an oxide of the material (metal or semimetal) of the film 3. The insulation film 15C is composed of an oxide of the material (metal or semimetal) of the film 3 and the material (silicon) of the silicon-containing film 13.

In this case, since the coating of the entire surface of the soft magnetic powder 1 can be sufficiently performed by the silicon-containing film 13 in the above manner, in the heating, the oxide film (the insulation film 15A or the insulation film 15B and the insulation film 15C) can be sufficiently formed. In this case, since the heating can be performed at a high temperature for a long time period, the bonding of the particles can be strong.

In particular, when aluminum is used as the metal of the film 3, the insulation film 15A and the insulation film 15B formed after the heating are composed of aluminum-silicon oxide, the insulation properties are better. In the above manner, a soft magnetic material 16, in which the surface and the interface of the soft magnetic powder is subjected to insulating coating, is produced.

As described above, in the production method for the soft magnetic material 16 of the second embodiment, since the coating of the entire surface of the soft magnetic powder 1 can be sufficiently performed, the effects (the improvements in the magnetic properties and the productivity) after the compaction in the first embodiment can be obtained better. Even when amount of the film 3 is small, the above effects can be obtained by the coating of the silicon-containing film 13, so that material amount of the film 3 can be reduced. As a result, the production cost can be reduced. Since the insulation properties of the insulation film (the insulation film 15A or the insulation film 15B and the insulation film 15C) are better, generation of eddy current loss of the soft magnetic material can be prevented, so that magnetic properties can be further improved. Since the strength can be further improved, mechanical properties can be further improved. The above effects can be obtained in the soft magnetic material 16 better than in the conventional soft magnetic material having the insulation film in which the overall thickness is the same. Thus, the realization of the high resistance, and the improvement in the productivity and in the magnetic properties can be simultaneously performed.

### EXAMPLES

The embodiments of the present invention will be explained in detail hereinafter with reference to concrete examples.

### 1. Example 1

### Example of the First Embodiment (Coating by Only Film 3)

### A. Evaluation of Properties of Green Compact

First, evaluation of properties was performed on green compacts of a sample 11 and a comparative sample 11 of the first embodiment according to the present invention. In the sample 11 of the first embodiment, a water atomized pure iron powder, which included 0.1 mass % of O, was prepared. An aluminum film having a thickness of about 20 nm was formed as a film (metal film) on the water atomized pure iron powder by sputtering. Regarding calculation of the thickness of the film, it was assumed that the aluminum film was uniformly coated on the entire surface of the powder, and based on this assumption, the thickness of the aluminum film was calculated from a specific surface area of the pure iron powder and a coated amount of aluminum. Next, by using a die, which had a rectangular parallelepiped shape and a surface having a size of 10 mm×40 mm, and a die, which had a ring shape and an outer diameter of 40 mm and an inner diameter of 25 mm, compaction was performed on the powder having the aluminum film. The compaction pressure was set at 600 MPa. Thus, a green compact having a rectangular parallelepiped shape was produced and a green compact having a ring shape was produced.

In the comparative sample 11, in the same manner as the sample 11, a water atomized pure iron powder was prepared, and an aluminum film having a thickness of about 20 nm was formed as a film (metal film) on the water atomized pure iron powder. Next, the powder having the aluminum film was subjected to heating, the aluminum film was oxidized, and an aluminum oxide film was formed as an insulation film. The heating was performed at a temperature of 500 degrees C. in the air. Next, compaction was performed on the powder having the aluminum oxide film by using the same dies as those for the sample 11. The compaction pressure was set in the same manner as in the sample 11. Thus, a green compact having a rectangular parallelepiped shape was produced and a green compact having a ring shape was produced.

The compactability of the green compacts of the sample 11 and the comparative sample 11 were examined. The results are shown in Table 1. In the green compact of the sample 11, cracks and fine chips were not observed, and the compactability was good. In the green compact of the comparative sample 11, cracks and fine chips were observed, and the compactability was inferior.

The density and the three-point bending strength of each green compact of the sample 11 and the comparative sample 11 having the rectangular parallelepiped were measured. Regarding the density, the weight and the size thereof were measured, and the density was calculated as a relative density by using the following equation.

Relative density (%)=((density of green compact)/(true density))×100

The three-point bending strength test was performed based on JIS (Japanese Industrial Standards) R 1601. In this case, the span was 30 mm, and the head speed was 0.5 mm/min. The results are shown in Table 1. In Table 1, in the measurement results of the three-point bending strength test, the result of the green compact of the comparative sample 11 is used as a standard (=1), and the result of the green compact of the sample 11 are shown.

TABLE 1

| | | relative density | three-point bending |
|---|---|---|---|
| | compactability | % | strength |
| sample 11 | GOOD | 92 | 2.67 |
| comparative | NG | 88 | 1 |
| sample 11 | | | |

As shown in Table 1, in the green compact of the sample 11, the relative density and the three-point bending strength were higher than those in the green compact of the comparative sample 11. From the above results of the compactability, the relative density, and the three-point bending strength, it was confirmed that the compactability, the density, and the strength can be improved in the production method for the green compact according to the first embodiment than in the conventional production method.

### B. Evaluation of Properties of Soft Magnetic Material.

Next, evaluation of properties was performed on soft magnetic materials. In a sample 12 of the present invention, the green compact of the sample 11 was subjected to heating. The heating was performed at a temperature of 600 degrees C. in the air. Thus, a soft magnetic material having a rectangular parallelepiped shape was produced and a soft magnetic material having a ring shape was produced. The green compact of the comparative sample 11 having a rectangular parallelepiped shape and the green compact of the comparative sample 11 having a ring shape were used as the comparative sample 12. In the comparative sample 13, in the same manner as in the sample 12, the heating was performed on the green compact of the comparative sample 11 having a rectangular parallelepiped shape and the green compact of the comparative sample 11 having a ring shape, and a soft magnetic material having a rectangular parallelepiped shape was produced and a soft magnetic material having a ring shape was produced.

The electrical resistivity of the soft magnetic material of the sample 12 having a rectangular parallelepiped shape was measured by using a four-terminal method, and the electrical resistivity thereof was ten times as large as that of the green compact of the sample 11 having a rectangular parallelepiped shape, which was measured in the same manner as the sample 12. Thus, it was confirmed that the aluminum film was oxidized to an aluminum oxide film which is as an insulation film.

Winding was performed on the soft magnetic material of the sample 12 having a ring shape, the green compact of the comparative sample 12 having a ring shape, the soft magnetic material of the comparative sample 13 having a ring shape by using a magnet wire having a diameter of 0.6 mm. In this case, the number of primary turns was 100, the number of secondary turns was 30, and an eddy current loss was measured by using a B-H analyzer (IWATSU ELECTRIC CO., LTD., product SY-8232). Three-point bending strength of each soft magnetic material of the sample 12 and the comparative sample 13, which had a rectangular parallelepiped shape, was measured in the same manner as in the sample 11. The results are shown in Table 2. The three-point bending strength result of the comparative sample 12 is the three-point bending strength result of the green compact of the comparative sample 11 having a rectangular parallelepiped shape. In Table 2, in the measurement results of the eddy current loss and the three-point bending strength, each result of the green compact of the comparative sample 12 is used as a standard (=1), and each result of the soft magnetic materials of the sample 12 and the comparative sample 13 is shown.

TABLE 2

| | temperature of | | |
|---|---|---|---|
| | heating after | magnetic properties | three-point bending |
| | compaction | eddy current loss | strength |
| sample 12 | 600 degrees C. | 0.29 | 10 |
| comparative | no heating | 1 | 1 |
| sample 12 | | | |
| comparative | 600 degrees C. | 1.43 | 8 |
| sample 13 | | | |

As shown in Table 2, the eddy current loss of the soft magnetic material of the sample 12 was one third or less of that of the green compact of the comparative sample 12 and that of the soft magnetic material of the comparative sample 13. The three-point bending strength of the soft magnetic material of the sample 12 was higher than those of the green compact of the comparative sample 12 and the soft magnetic material of the comparative sample 13. From the above results of the eddy current loss and the three-point bending strength, it was confirmed that the magnetic properties and the strength can be improved in the production method for the soft magnetic material of the first embodiment than in the conventional production method.

### 2. Example 2

### Example of the Second Embodiment (Coating by Film 3 and Silicon-Containing Film 13)

In a sample 21 of the second embodiment according to the present invention, a water atomized pure iron powder, which included 0.1 mass % of O, was prepared. An aluminum film was formed as a film (metal film) on the water atomized pure iron powder by sputtering. Next, a powder of a silicone resin was mixed with the water atomized pure iron powder having the film, so that a silicon-containing film was formed on the surface of the film. In this case, the total amount of silicone was 0.5 wt %. Next, by using a die which had a ring shape having an outer diameter of 40 mm and an inner diameter of 25 nm, compaction was performed on the powder having the aluminum film and the silicon-containing film. The compaction pressure was set at 1000 MPa. Thus, a green compact having a ring shape was produced. The green compact was subjected to heating. The heating was performed at a temperature of 600 degrees C. in the air. Thus, a soft magnetic material having a ring shape was produced.

In soft magnetic materials of samples 22 and 23 of the second embodiment, a lithium film and a magnesium film were formed as a film instead of the aluminum film, and the production method for the samples 22 and 23 was the same as that of the sample 21 other than the formation of the lithium film and the magnesium film. In a sample 24, only the aluminum film was formed on the surface of the water atomized pure iron powder, and the sample 24 was produced by the same method as that of the sample 11 of the first embodiment. In a comparative sample 21, a soft magnetic material having a ring shape was produced in the same method as in that of the comparative sample 11 of the first embodiment other than that the heating is performed on the water atomized pure iron powder without formation of the film and the silicon-containing film on the surface of the water atomized pure iron powder.

Regarding the samples 21 to 24 and the comparative sample 21, the density of each green compact was measured, and the electrical resistivity, the hysteresis loss, and the eddy current loss of each soft magnetic material were measured. Iron loss was obtained by sum of the hysteresis loss and the eddy current loss. The results are shown in Table 3. The measurement of the density, the electrical resistivity, and the eddy current loss were performed in the same manner as in the example of the first embodiment. The measurement of the hysteresis loss was performed by using the B-H analyzer (IWATSU ELECTRIC CO., LTD., product SY-8232). The density was the measurement result of the sample before the heating. The electrical resistivity, the hysteresis loss, and the eddy current loss were the measurement results of the sample after the heating. The density was obtained as the relative density in the same manner as in the example 1. In Table 3, in the measurement results, each result of the sample 24 is used as a standard (=1), and each result of the samples 21 to 23 and the comparative sample 21 is shown.

TABLE 3

| | | magnetic | magnetic | relative |
|---|---|---|---|---|
| | electrical | properties | properties | density |
| | resistivity | eddy current loss | hysteresis loss | % |
| Sample 21 | 40 | 0.06 | 1.14 | 1 |
| Sample 22 | 35 | 0.07 | 1.15 | 1 |
| Sample 23 | 30 | 0.08 | 1.15 | 1 |
| Sample 24 | 1 | 1 | 1 | 1 |
| comparative | 0.20 | 2.30 | 1.10 | 1 |
| sample 21 | | | | |

The compactability of the green compact of the sample 21 of the second embodiment was examined. As a result, in the green compact of the sample 21, cracks and fine chips were not observed, and as shown in Table 3, the density of the green compact of the sample 21 was approximately equal to that of the sample 24 of the first embodiment, and the compactability of the sample 21 was good. The compactability of each green compact of the sample 22 and 23 of the second embodiment was examined. As a result, each compactability of the samples 22 and 23 was good.

As shown in Table 3, the electrical resistivity of the soft magnetic material of the sample 21 of the second embodiment was much higher than that of the comparative sample 21, and the electrical resistivity of the soft magnetic material of the sample 21 was about 40 times as high as that of the sample 24 of the first embodiment. The eddy current loss of the soft magnetic material of the sample 21 was reduced by 94% in comparison with that of the comparative sample 21. The hysteresis loss of the soft magnetic material of the sample 21 was reduced by the heating so as to be approximately equal to that of the comparative sample 21. As shown in Table 3, in the approximately same manner as the soft magnetic material of the sample 21, the respective properties of the samples 22 and 23 were improved in comparison with the comparative sample 21 and the sample 24 of the first embodiment.

From the above results, it was confirmed that the compactability and the density of the green compact can be improved by the soft magnetic material or the production method therefor of the second embodiment according to the present invention in which the film and the silicon-containing film are formed on the surface of the soft magnetic powder. In addition, it was confirmed that in comparison to the conventional production method and the production method for the soft magnetic material of the first embodiment in which only the film is formed on the surface of the soft magnetic powder, in the soft magnetic material or the production method therefor of the second embodiment according to the present invention, the electrical resistivity can be much higher, and in particular, the drastic reduction of the eddy current loss of the magnetic properties can be performed, so that insulation properties of the oxide film can be greatly improved.

1-7. (canceled)

8. A soft magnetic material produced by compaction of a soft magnetic powder which includes iron, comprising:
an insulation film formed on a surface and an interface of the soft magnetic powder of a green compact, wherein
the insulation film is an insulation film including an oxide of a metal or a semimetal and silicon.

9. A soft magnetic material produced by compaction of a soft magnetic powder which includes iron, comprising:
an insulation film formed on a surface and an interface of the soft magnetic powder of a green compact, wherein
the insulation film has:
a first insulation film which is composed of an oxide of a metal or a semimetal; and
a second insulation film which is composed of an oxide of the metal or the semimetal and silicon, wherein
the first insulation film and the second insulation film are formed in turn from the surface of the soft magnetic powder.

10. A soft magnetic material according to claim 8, wherein
an oxide of the metal and an oxide of the semimetal have absolute values of standard free energy of formation, and the absolute values are larger than that of an iron oxide.

11. A production method for a soft magnetic material, comprising:
forming a film composed of a metal or a semimetal on a surface of a soft magnetic powder including iron and oxygen;
compacting the soft magnetic powder having the film, so that a green compact of the soft magnetic powder is obtained;
heating the green compact, so that the film of the green compact is oxidized to an insulation film.

12. A production method for a soft magnetic material, comprising:
forming a film composed of a metal or a semimetal on a surface of a soft magnetic powder including iron and oxygen;
forming a silicon-containing film including silicon on a surface of the film;
compacting the soft magnetic powder having the film and the silicon-containing film, so that a green compact of the soft magnetic powder is obtained; and
heating the green compact, so that the film and the silicon-containing film of the green compact are oxidized to an insulation film, wherein
the insulation film is an insulation film composed of an oxide of the metal or the semimetal and silicon.

13. A production method for a soft magnetic material, comprising:
forming a film composed of a metal or a semimetal on a surface of a soft magnetic powder including iron and oxygen;
forming a silicon-containing film including silicon on a surface of the film;
compacting the soft magnetic powder having the film and the silicon-containing film, so that a green compact of the soft magnetic powder is obtained; and
heating the green compact, so that the film and the silicon-containing film of the green compact are oxidized to an insulation film, wherein
the insulation film has:
a first insulation film which is composed of an oxide of the metal or the semimetal; and
a second insulation film which is composed of an oxide of the metal or the semimetal and silicon, wherein
the first insulation film and the second insulation film are formed in turn from the surface of the soft magnetic powder.

14. A production method for a soft magnetic material according to claim 9, wherein
an oxide of the metal and an oxide of the semimetal have absolute values of standard free energy of formation, and the absolute values are larger than that of an iron oxide.

15. A soft magnetic material according to claim 11, wherein
an oxide of the metal and an oxide of the semimetal have absolute values of standard free energy of formation, and the absolute values are larger than that of an iron oxide.

16. A production method for a soft magnetic material according to claim 12, wherein
an oxide of the metal and an oxide of the semimetal have absolute values of standard free energy of formation, and the absolute values are larger than that of an iron oxide.

17. A production method for a soft magnetic material according to claim 13, wherein
an oxide of the metal and an oxide of the semimetal have absolute values of standard free energy of formation, and the absolute values are larger than that of an iron oxide.
